(19) United States
(12) Patent Application Publication
(10) Pub. No.: US 2012/0243113 A1
(43) Pub. Date: Sep. 27, 2012

(54) Hybrid Cool Roof

(76) Inventor: Marc Jensen, Los Gatos, CA (US)

(21) Appl. No.: 13/195,798

(22) Filed: Aug. 1, 2011

Related U.S. Application Data
(60) Provisional application No. 61/369,905, filed on Aug. 2, 2010.

(51) Int. Cl. E04D 13/16; G02B 5/08

(52) U.S. Cl. 359/850; 359/871; 359/883

(57) ABSTRACT

The hybrid cool roof has a near horizontal solar reflecting surface, and a second esthetic surface, which is angled to the street view. The esthetic surface gives the hybrid cool roof the appearance of a conventional roof when viewed from street level, giving the roof a decorative appearance while having the cooling cost functionality of a conventional cool roof. At times when the sun angle is low in the sky, such as wintertime, the hybrid cool roof is able to absorb solar radiation, lowering heating costs. Thus, the hybrid cool roof has an ideal combination of the function and appearance of conventional cool roofs and traditional roofs, while mitigating the disadvantages of both.

The present application claims priority to the U.S. Provisional Application entitled “Cool Roof Material with Variable Angle Heat Shielding” application No. 61/369,905 filed Aug. 2, 2010.

### BACKGROUND OF THE INVENTION

This invention relates to roof materials, specifically to such roof materials that reduce the thermal gain of the roof.

Roofing materials that are reflective to light, especially the infrared bands, are often described as “cool roofs”. Cool roofs can reduce cooling costs for buildings by reflecting the light in the infrared bands and so limiting heat absorption. Typically these roof materials lower the temperatures at the roof surface, for instance from temperatures of 180° F. to 100° F.

With the roof maintained at a lower temperature, the energy cost to cool the building is greatly reduced. It can be as much as six times more expensive to cool a building as to heat it. A reduction in energy to cool a building provides a way to reduce greenhouse gas production by reducing the energy requirements to cool buildings. In addition, the reduced energy costs can reduce the costs required to operate a building. Cool roofs can be installed as a purpose built tile, shingle or membrane. Cool roof materials are available commercially for most common forms.

Existing cool roof tiles, shingles and membranes designs attempt to have a uniform reflectance across the surface. Unfortunately, because cool roofs normally appear white or light colored when viewed from typical vantage points, these new roofs have been limited in their adoption. Esthetic disincentives have prevented the adoption of cool roofs in a number of markets where esthetic appearance requirement has taken precedence over functional needs. Also, currently available white roofs can unduly cool a home in colder months when solar heat absorption could otherwise lower heating fuel usage.

It would be an important advancement in the field of cool roofs if there was a cool roof that eliminated the esthetic discouragement for adoption into the residential market, and avoided the disadvantage of increased cooling, and thus increased heating needs, in colder months.

### SUMMARY OF THE INVENTION

The hybrid cool roof provides, for the first time, a roof with the esthetic appearance of a traditional roof, but with the building cooling properties of a white or light colored “cool” roof. Thus, the hybrid cool roof has the unique capability of combining key functionalities of currently available cool roofs and traditional roofing.

Because the hybrid cool roof's hybrid capabilities also extend to mitigation of temperature changes at both ends of the temperature scale, the hybrid cool roof provides a unique totality of functionality unmatched by any currently available roofing.

Traditional Appearance From the street level, the hybrid cool roof appears to be a traditional dark roof. The observed color and appearance of the hybrid cool roof, such as tile color, style and texture, can be selected for purely esthetic reasons. Despite its appearance to the street level observer, the hybrid cool roof actually performs functionally as a cool roof, approaching the building cooling capacity of a white or other light colored roof. From an airplane view, a large cityscape of hybrid cool roofs will appear light, much as roofs appear from above on buildings having short street façades with a tar and gravel flat roof for the majority of the roof area.

The ability of the hybrid cool roof to appear as a traditional roof, in virtually any desired color, texture and style, allows the advantages of cool roof technology to reach the residential market, which to present has been highly resistant to installation of white or light colored roofs (Aug. 27, 2004 Berkeley Lab Science Beat “Cool Colors, Cool Roof”). The hybrid cool roof also allows commercial buildings to have the advantage of cool roof functionalities when these buildings are in communities where esthetics are key to providing such energy saving installations. In many communities, zoning or gated community regulations require an esthetic standard appearance to home and commercial roofs.

Cool Roof Functionality Depending on design, the hybrid cool roof achieves close to the functionality of conventional cool roofs in warm months. However, because of increased savings of building heating requirements in winter months, the hybrid cool roof can provide even great energy savings than a conventional cool roof over the course of a year.

The hybrid cool roof, in the hotter months, can have the energy saving functionality as compared to conventional cool roofs of about 75-100%, such as about 80-95%, and including about 85-90%. In cooler months, the hybrid cool roof will actually have the opportunity to exceed the functionality of conventional cool roofs by harvesting solar heat through its dark façade esthetic surface, as described in further detail below. Therefore, over the course of a year, the hybrid cool roof can have functionality as compared to conventional cool roofs of 75-120%, such as about 80-110%, and including about 85-100%.

As a result of its unique designs, during warmer months, the hybrid cool roof achieves most of the operating cost savings which traditional cool roof technologies are able to glean. By example, many monitoring studies in California and Florida have demonstrated that increasing roof solar reflectance to 0.60 from the range of 0.10 to 0.20 results in savings in building cooling energy requirements in excess of 20% (Akbari et al. 2005; Akbari 2003; Akbari et al. 2001; Akbari et al. 1997; Konopacki and Akbari 2001; Parker et al. 1998; Parker et al. 1995). Thus, depending on the building in which it is installed, the hybrid cool roof achieves energy savings of about 5-40%, such as about 10-30%, and including about 15-20%.

Modulates Seasonal Temperatures The hybrid cool roof innovation additionally provides for optimal seasonal heat and cooling properties without resorting to moving parts, as a natural function of the sun's seasonal angle. Currently available white roofs can unduly cool a home in the cooler months when solar heat absorption would otherwise lower heating fuel usage. With the hybrid cool roof's seasonally optimizing feature, in the winter months, the hybrid cool roof actually provides better temperature control than currently available cool roofs. Thus, the hybrid cool roof is a roof for all seasons.

Additionally, the hybrid cool roof's seasonal variations in function optimally modulate for the particular geographical temperate zone location of a building. As described in more detail below, conventional cool roofs have limited advantage in higher latitudes and cool climates. This is due both to the lessened dependence on cooling, but also the net heat loss suffered in the colder months due to loss of natural solar heating. The full annual energy savings of the hybrid cool roof for specific regions and applications can be calculated using the Oakridge and Lawrence Berkeley Laboratory calculation tool which can be accessed at http://www.roofcalc.com/.

As a result of the poor match to need in certain regions, many regional markets have failed to adopt cool roof technology. However, the hybrid cool roof captures the winter solar gain, and makes cool roof advantages practically available to these markets.

Optimizes Useful Roof Life The lifespan of roofs is limited in part due to the high temperatures they must endure. This concept is described by the Ahranius Rate equations that show that a chemical or thermal process can be increased by an exponential factor even as the temperature only increases at a linear rate. The useful lifespan of a roof is also decreased by overall fluctuation in temperature due to material fatigue effects.

Because the effect of the hybrid cool roof's temperature moderating capabilities provide for less extremes in temperature changes, both the roofing itself and the building it serves will suffer less material fatigue when hybrid cool roof systems are employed. As such, both the functional life of the roof and the building as a whole will be extended.

Generally, for each 10° F. decrease in roof temperature, a full year is added to the useful life of a roof. A roof's lifespan is affected by the slope of the roof, the material used to build the roof, and the weather conditions in the region. A slate roof can last up to 75 years, whereas a roof made of selvage- or asphalt-based materials can show significant signs of wear within 12 years. 15 years is the typical life of asphalt shingles, whereas 7 years is typically for tar and gravel roofs. The following average roof life spans are based on data from Freddie Mac*, the lender, and data published in Realty Times:

| | |
|---|---|
| Asbestos shingle roof | 30-50 years |
| Asphalt roof | 15-20 years |
| Fiberglass roof | 15-20 years |
| Slate roof | 40-75 years |
| Rolled/asphalt roof | 12-20 years |
| Wood shake/shingle roof | 15-20 years |

Thus, the hybrid cool roof can contribute considerable economic value through prolongation of the useful roof life.

The hybrid cool roof's effect reduces the roof temperature in the warm months, but also serves to provide warming of the roof in the cool months. This extra advantage over conventional cool roofs will further increase the lifespan of the roof materials. The combined temperature modulation effect of the hybrid cool roof results in additional cost savings to the homeowner.

The hybrid cool roof can improve roof lifespan by mitigation of material fatigue as compared to that of conventional roofs by about 10%-100%, such as about 20%-70% and including about 30-40%. The hybrid cool roof provides a smaller, additional, gain in lifespan as compared to currently available cool roofs due to mitigation of cooling in colder months. The hybrid cool roof can extend the functional life of a roof by about 1-30 years, such as about 5-15 years, including about 10 years.

Structural Design The hybrid cool roof's unique design includes sub-surfaces that reflect visible and infrared solar radiation when the angle of the sun is at or greater than a predetermined angle in the sky. By design, when viewed from the street, the white roofing material of the hybrid cool roof, its solar reflecting surface, has an appearance that is not reflective to light visible when viewed from street level. Rather, the dark, standard appearance façade surface of the roof, the esthetic surface, is seen by the street level observer, giving the appearance of a standard dark roof.

As described below, the hybrid cool roof is typically a member of a larger structural system of a building that includes the hybrid cool roof devices of the invention, as well as methods of using the systems and devices in a variety of different applications. Additional or alternative aspects of the invention include a material system that can be incorporated into the sides of buildings or other physical structures. This material can be incorporated into vehicles as well as buildings.

Implementation with Conventional Cool Roofing Materials The hybrid cool roof system design can be implemented using many existing cool roof materials and constructs. By example, the hybrid cool roof system can be accomplished with existing foam systems. Foam systems can be divided into the field-applied and factory-applied categories. Field-applied foam systems are similar to field-applied coatings, as they are sprayed on in liquid form and harden as they set on top of the roof. Factory-applied foam systems are formed into rigid panels and coated with a reflective coating. The foam usually gives the roof system additional insulation properties. These qualities make foam systems compatible with both hybrid cool roof systems applied as a retrofit, and as a de novo production in the manufacturing plant.

Metal roofing products can be shaped to look like shingles, or shakes, or to fit unique curvatures, in addition to a typical “standing seam” configuration. This makes metal roofing products a very good fit to the hybrid cool roof system. Metal roofing products come in a variety of textures and colors, including some darker “cool” colors with special additives that allow these dark colors to achieve significantly greater reflectance than previous versions of the same product. Thus, metal for use in the hybrid cool roof system will be synergistic with the gains provided with the present invention.

Currently available cool roof coatings are very compatible with the hybrid cool roof system when used in combination with an angled spacer. Roof coatings can be divided into two categories: field-applied and factory-applied. Field-applied coatings are applied directly onto the roof surface, either on a new roof assembly or over an existing roof surface. These can be applied over top of just about any roof material, so long as the right coating is selected. Factory-applied coatings are applied at the factory prior to distribution. Examples of factory-applied coatings include coatings applied to metal and glazes that are applied to tiles.

The hybrid cool roof system can also be implemented using shingles, slate, or tile. All of these product types use the same concept, where pieces fit together to form a roof. Asphalt shingles are fairly common for residential roofing applications, probably because they are relatively inexpensive and simple to install. Their typically flat profile will require angled spacers to provide compatibility with the hybrid cool roof system. Slate and tile products also come in a wide variety of colors, shapes and textures, and, because of their heavy mass, they have thermal properties that may yield additional energy savings beyond their reflectance and emittance properties. Thus, slate and tile will be synergistic to the advantages of the hybrid cool roof system.

Retrofitting Previously Installed Roofing The hybrid cool roof system can be retrofitted with previously installed roofing systems. In the case of flat asphalt shingles, the hybrid cool roof modules can be installed directly on the prior roofing, if it is in sufficiently good repair. If previously installed roofing is at an appropriate angle, the hybrid cool roof system retrofit may be accomplished by selectively painting the rear portions of the tiles. Also, a solar reflecting surface of the correct angle can be installed directly onto existing, previously installed tiles. This retrofitting approach is particularly appropriate when the tiles have an expected long lifetime, such as slate or ceramic tiles, by example.

Because of the excellent esthetic qualities of the hybrid cool roof, it is also possible to retrofit a portion of a roof, rather that undertake a full reroofing or over-roofing. The roof face receiving the greatest solar impact would be the most likely candidate for a partial installation.

Materials The hybrid cool roof can be constructed with a number of the common roofing materials, including concrete tile and ceramic tile. The solar reflectance and thermal emittance of these materials determine their suitability for use with the hybrid cool roof's solar reflecting surface. Both properties are measured from 0 to 1 and the higher the value, the “cooler” the roof. Thousands of examples of commercially available cool rated tiles and surface treatments are provided by the Cool Roof Rating Counsel at http://www.coolroofs.org/products/results.php.

Factory and field applied coatings are useful, as they can be easily applied to hybrid cool roof tiles. Applied paints and reflective granules are also useful in constructing the hybrid cool roof tiles and modules. The solar reflecting surface can be produced through the use of commercial paints and coats. Examples of such coating include ARC's Cooltile IR Coatings™, a five coat polymeric membrane.

Constructs of the polymeric cool roof materials are also useful in combination with support structures with features that support the angle needed to produce the view surface. Many commercial polymeric cool roof materials can be used to provide the solar reflecting surface of the hybrid cool roof.

By example, Custom-Bilt Metals' aluminum shakes and shingles can be augmented with Titan® Cool Roof, a 70 percent PVDF (Polyvinylidene Fluoride) resin-based coating system. As applied to the hybrid cool roof, once a metal shingle is produced in the form of the hybrid cool roof profile, the solar reflecting surface can be selectively treated with this polymer system, without regards to appearance.

Other variants would include providing an overall coat to the entire shingle to generally improve reflectance, but limiting the high titanium dioxide content layer, with its concomitant white color, to the solar reflecting surface. A hybrid cool roof with this configuration will reflect up to 70% of the sun's energy and save up to 20% on cooling costs.

As another example, using Custom-Bilt Metals FusionSolar™ thin-film solar laminate product, the hybrid cool roof can be provided with integrated photovoltaic capability. Dow's Powerhouse Solar Shingles can also be designed with the hybrid cool roof profile to provide better esthetics while improving photovoltaic capacity through better orientation of the active face.

Commercial cool roof materials can be overlaid on the solar reflecting surface of the hybrid cool roof to optimize solar reflection capabilities. Many cool roof materials can be used, such as Owens Corning TruDefinition Duration Shingles, Duration® Premium Shingles, Oakridge®, and Supreme in Shasta White, Duration® Premium Cool Frosted Oak, Harbor Fog and Sunrise, Timberline cool series Cool Antique Slate, Cool Barkwood, Cool Weathered Wood, Cool White.

An advantageous approach to providing increased functionality to hybrid cool roof's solar reflecting surface is by the application of solar reflecting paints and coatings, including polymers and powder coatings, among others. Examples of such coatings are 3M Scotchkote Liquid roofing membranes, Sherwin-Williams greenstar coatings with ceramic and titanium-based surface, the Shepard's Color Company IR-reflective Arctic® pigments, and the Hyperseal Inc. roof coating system, among others.

Elastomeric material can also be used to provide small features for the hybrid cool roof, as shown, for example, in FIG. 8a, below. Elastomeric material is commercially available from a number of different manufacturers, EDPM and PVC elastomeric materials with a titanium dioxide, zinc oxide coating.

Energy Conservation The opportunities for energy conservation and cost savings by the adoption of the hybrid cool roof technology system is substantial. Taking California as an example, Commercial buildings account for about one third of California's total electricity consumption, at a cost of about $9 billion per year. The energy consumption associated with space cooling accounts for a significant portion of commercial building electricity use in California, and is increasing at a significant rate, particularly in the hotter inland areas. Space cooling plays a major role in determining the magnitude and timing of peak electrical demand. (Effects of Global Climate Changes on Building Energy Consumption and its Implication on Building Energy Codes and Policy in California September 2009 CEC-500-2009-006)

Konopacki et al. (1997) estimate that the U.S. could save more than $750 million (M) per year in net energy expenditure (cooling-energy cost savings minus heating-energy cost penalties). These cost savings account for only the direct effect of cool roofs, and would double once the values of indirect energy savings and smog reduction from cooling of the ambient air are included (Akbari et al. 2001, Akbari, Hashem, 2008. Procedure for measuring the solar reflectance of flat or curved roofing assemblies. Lawrence Berkeley National Laboratory: Lawrence Berkeley National Laboratory. Retrieved from: http://www.escholarship.org/uc/item/5173j55j

For the purposes of this application, the terms “white roof” or “white roofing material”, or “cool roof” or “cool roofing material” refer more broadly to any roofing material or paint which provides improved reflection of solar energy or the emittance of solar heat. All references cited in this application are herein Incorporated by reference in their entirety.

### BRIEF DESCRIPTION OF THE FIGURES

FIG. 1a is a three dimensional view of both ledge and staggered hybrid cool roof tiles,

FIG. 1b depicts the line of sight of a street observer of the hybrid cool roof,

FIG. 2 is a cross section of the hybrid cool roof showing seasonal variations of its function as a result of changed sun angle,

FIG. 3 is a cross sectional view of the roof material of the hybrid cool roof using a relatively large form factor for the reflecting surface,

FIG. 4 is a cross sectional view of the roof material of the hybrid cool roof using a relatively small form factor for the reflecting surface,

FIG. 5 is a cross sectional view of the hybrid cool roof where reflecting surface is provided in a series of steps, blocks or ledges,

FIG. 6 is a cross sectional view of the hybrid cool roof where passageways allow humidity and hot air to escape from under the roof material,

FIG. 7a is a cross sectional view of the hybrid cool roof where the esthetic surface is a stand alone rectangular pillar providing support for the solar reflecting surface,

FIG. 7b is a cross sectional view of the hybrid cool roof where the esthetic surface is a stand alone cylindrical pillar which provides support for the solar reflecting surface,

FIGS. 8a-c are cross sectional views of the hybrid cool roof constructed with elastomeric material over a thermal spacer in a reel-to-reel fashion, or manufactured with faceted tiles,

FIG. 9 is a cross sectional view of an embodiment of the hybrid cool roof where the reflecting surface is provided with an overhang,

FIG. 10 shows the fabrication of the hybrid cool roof with tiles on a linear conveyor belt in a continuous system.

FIG. 11 shows the fabrication of the hybrid cool roof on a linear conveyor belt where the facets are formed after the material is produced.

FIG. 12 shows the installation of the prefabricated hybrid cool roof tile.

FIG. 13a-c shows an embodiment of the hybrid cool roof where the surface has pyramidal shapes, the esthetic surface produces an overhang, and the shapes provide water runoff channeling.

FIG. 14 shows the results of tests demonstrating the efficacy of a hybrid cool roof prototype as compared to standard cool roofs.

FIG. 15 shows possible non standard roof pitches.

FIG. 16 shows the angle of the sun in the sky as it varies during the day and over the year for one latitude location.

FIG. 17 shows the energy savings from cool roofs in different regions, in this case on commercial buildings.

### DETAILED DESCRIPTION

The hybrid cool roof uniquely provides a roof surface with the esthetic appearance of a traditional roof, but with the building cooling properties of a white roof. The hybrid cool roof also combines key functionalities of currently available cool roofs and traditional roofing. The hybrid cool roof's hybrid capabilities mitigate temperature changes at either end of the temperature scale, providing a unique totality of functionality both in performance and appearance that is unmatched by any currently available roofing.

To accomplish these unique capabilities, the hybrid cool roof is designed with two functional surfaces: the solar reflecting surface and the esthetic surface. The solar reflecting surface is hidden by the façade of the esthetic surface from a street view. The solar reflecting surface accomplishes the cooling function of the hybrid cool roof. The esthetic surface provides the appearance to the public of a traditional roof.

Broad Esthetic Choice By design, the hybrid cool roof's solar reflecting surface is designed to be positioned in a non-observable direction. This key design feature provides an increased level of freedom for a designer to have colors and appearances from other directions that would not be typical for the incident angle of the sun. For example, when viewed from the sidewalk in front of the building, the hybrid cool roof could appear to be black, green, or red. When viewed from overhead, the same hybrid cool roof would appear white.

This important design flexibility can have an additional advantage in that during the winter months when the sun angle is lower in the sky, the hybrid cool roof can absorb solar radiation but in the summer months, the hybrid cool roof will reflect solar radiation.

Texture of a roof is also an important decorative choice for many homeowners and building owners. Roofing materials on the hybrid cool roof's esthetic surface can be chosen to match the appearance of a cedar shingle roof for example. Having a roof with texture adds to the desirability of the roof from an esthetic sense. As described in more detail below, the hybrid cool roof texturing will often have useful functional, as well as esthetic, advantages, such as water channeling and self-cleaning.

Seasonal Advantages In winter months, the hybrid cool roof's esthetic surface provides a means of collecting solar heat to mitigate unwanted cooling by the solar reflecting surface. In fact, the esthetic surface can be designed to become the major surface of solar radiation impact in winter months, subtly shifting the overall dynamic of the hybrid cool roof to one better optimized for cold weather.

The unique and novel approach of hybrid cool roof allows it to be tailored in design to function optimally for the latitude of the building site as well as the slope of the roof. By producing a roof material that is solar reflective in one direction but not in another, the hybrid cool roof's unique and novel features cause light to be transmitted into the building when the sun is at angles low on the horizon but blocked when light is directly overhead. The hybrid cool roof tiles can be supplied such that the angle of the solar reflective film on the solar reflecting surface is flat or at slight angles once they are applied.

The hybrid cool roof typically provides at least the same benefits that a monolithic cool roof has, reducing the temperature excursions that cause degradation of roofing materials and the materials of the building in the summer months. However, the hybrid cool roof's ability to capture solar heat during cold months actually gives it an improved benefit over currently available cool roofs.

As a result of mitigation of temperature excursions, the hybrid cool roof increases the longevity of the building and the roofing materials. It also has all the other advantages of reducing the urban heat island effect and local heating due to hot roofs as conventional cool roofs.

The hybrid cool roof provides the primary benefit of a cool roof. That is, it reduces either the power requirements for air conditioning or enables a building to forgo air conditioning requirements due to the reduced temperatures in the summer.

In addition, in contrast to a monolithic cool roof, the hybrid cool roof, with its ability to capture heat in the winter time with the lower solar angles reduces the temperature excursions in the winter to reduce fatiguing on the components due to extreme temperature cycling.

Self Cleaning Current cool roof materials that are monolithic collect dust and dirt over time. This deposited material degrades the ability of the cool roof surface to reflect the visible and infrared portions of the incident solar spectrum and thereby increases the heating of these materials during the day. As a result, these monolithic roofing materials require periodic cleaning to remove the dust and dirt.

As described in more detail below, several hybrid cool roof embodiments provide a means to increase the time required between cleanings. Synergistic with this feature are roof surfaces which have self-cleaning properties, such as Baumann et al, “Glass ceramic and metal substrates with a self-cleaning surface” U.S. Pat. No. 6,872,441 Issued, Mar. 29, 2005 assigned to Ferro GmbH.

An additional feature of certain embodiments of the hybrid cool roof is that the overhanging surfaces can be made to be flexible so that in rain and wind the reflective surface can bend and vibrate. The advantage of this feature is that the surface can shed dirt and dust that can reduce the material's ability to reflect the visible and infrared portions of the incident solar spectrum.

Another useful feature of the hybrid cool roof is the design opportunity to mount the reflective surfaces such that the rear portion of the surface does not contact the roof tile substrate. This provides a means so that dirt and dust that is transported down the roof slope do not flow onto the surface down slope from the surface above. A negative slope from the horizontal plane of the solar reflecting surface also increases self cleaning.

Air Flow Certain hybrid cool roof embodiments provide a means for increasing the cooling of the material due to air flow over the higher surface area of the material in comparison to typical building materials.

Additional features that can be added to the hybrid cool roof include small venting on the underside of the solar reflecting surface scales. These features provide an advantage in allowing humidity inside the structure to escape as well as allowing hot air to escape. By having the solar reflecting surface scales significantly overhang the vertical esthetic surface, the majority of wind-driven rain entering the vent holes in the solar tile is prevented.

Form Factor The form factor of the hybrid cool roof tiles can have numerous variations due to the flexibility of the system design. By example, these variations can include tiles and shingles, long continuous strips, and large flexible sheets. In the form factor of the tile or shingle, features can be added to the finished product to aid in installation including nail holes, alignment features and ridges to direct water runoff. Thermal insulation can be added to the roof tiles during manufacturing that reduces materials heat capacity.

In some embodiments of the hybrid cool roof, its objectives are achieved by having a multitude of surfaces on the roof. The solar reflecting surface is reflective to most forms of solar radiation. The esthetic surface, angled towards the horizontal plane or street view, can be provided with colors that would not necessarily be dictated by their solar absorption properties.

Scale Surface Features The range of scale of features available for the hybrid cool roof is extremely broad. These features can be designed anywhere from micron-size particles embedded in a roof that are flipped to orient one titanium oxide-coated surface towards the sun up to features that are half a meter to a meter in length. These reference points are the extremes of design, and most features will lie between these two outer reference points. The hybrid cool roof surface features will function in those ranges, as selected for a particular application or function. In the smaller ranges, the hybrid cool roof surface features can range from about 1μ-10 cm, such as about 100μ-1 cm, and including about 1 mm-10 mm. In the larger ranges, the hybrid cool roof surface features can range from about 10 cm-1 m, such as about 100 cm-500 cm, and including about 300 cm-400 cm.

Subsurface and Precipitation Management The hybrid cool roof is provided with a base material that is water resistant. The base material with the different pigmentations appropriate to the surface through coating or processes well know to a skilled artisan. The base material is water resistant, and that quality is not compromised by applying the solar or esthetic pigmentation to that foundation. Thus, the base material of the hybrid cool roof provides the primary water resistance to the system. The intrinsic water resistance of the hybrid cool roof system is formed by the base material.

The design of a horizontal or near horizontal angle of the solar reflecting surface runs counter to the prior approach of the industry to roof construction with tiles, as distinguished from tar and gravel flat roofs. A flat surface on a tiled roof would potentially provide challenges to water resistance, so the natural inclination has been to put an angle on that surface to have it shed water.

However, with the structure of the hybrid cool roof, the horizontal angle of the solar reflection surface can be designed without concerns as to water leakage, especially when the features are on a relatively small scale. As described in more detail below, there can be provided a slight angle to the solar reflecting surface depending on the range of design, without compromise to the key esthetic appearance of the hybrid cool roof from the street view.

In the design of the hybrid cool roof, potential challenges of precipitation pooling can be managed by system design providing the scale of the solar surfaces as small enough that water has no or minimal accumulation. Another design approach is to have diamond faceting, as show below, that provides channels for the water to run off by going down to either side of the little solar reflecting surface facets.

Additionally, surface tension of the water and fluid dynamics can be employed in the design of the hybrid cool roof system. By example, Kynar® is now widely used in roofing, and can be employed as a primary material for the construction of hybrid cool roofs. Kynar® is hydrophobic, as well as mold and mildew-resistant. The use of Kynar® provides a modification to the surface tension of the water so that rain or other precipitation will run off or get blown off the hybrid cool roof by the wind.

Precipitation pooling for the hybrid cool roof will only be a design consideration with surface features on the order of 500 cm-1 m. However, with smaller surface features, the hydrostatic pressure of the water is very minimal. In these cases, the fluid dynamic consideration is only capillary action. If the selected base material is water-resistant, the entire final structure will be water-resistant, eliminating pooling concerns.

As with other forms of precipitation, in the case of a small scale factor, the surface of the hybrid cool roof is not compromised by snow build-up. Essentially, these surface structures will have the mechanical effect to the snow fall of rugosities, that is a slightly more rugged surface. There would be no change to overall loading from that of a conventional roof.

The hybrid cool roof system can function well on fairly high pitched roofs, such as those typically employed in snow country. In addition, the ability of the hybrid cool roof system to provide solar heating to the roof in the winter also reduces the snow accumulation problem. A monolithic cool roof would be cold and aid the accumulation of snow and ice dams. By contrast the solar heating captured by the hybrid cool roof system melts the snow that accumulated on the roof much more effectively than a monolithic cool roof.

Solar Reflecting Surface Angle The solar reflecting surface of the hybrid cool roof tile can be produced at a number of different angles that match common roof angles. The design of the solar roof tiles would be such that it would work within a tolerance band of roof angles. For example, if the roof angle was 30°, then the solar tile would be appropriate between angles of 25° and 45°, or more. Calculating the angle for a specific roof slope will be obvious to the ordinary skilled artisan.

It may be advantageous in some roof applications to have the solar reflecting surface angle be negative to the horizontal plane, that is, angled away from the roof's slope to the point of exceeding the horizontal plane. By example, this would be useful in the case of very sharply angled roofs. In these embodiments of the hybrid cool roof, care will be taken to provide appropriate challenging of precipitation. When the features are relatively small, such as in the centimeter range, this is less of a concern.

Because of the sharp angle of the ground level observer to the hybrid cool roof, there is considerable leeway and flexibility in deviation of the solar reflecting surface from horizontal, in some cases at a greater angle than those described above. For the purposes of this application, “horizontal” refers to the position of the surface of the hybrid cool roof once installed on the building's roof. These angles can range from about −10° to 25°, such as from about −5° to 15°, and including from about 0° to 8°. Also, if the solar reflecting surface is covered with a reflective, but relatively esthetic surface, this angle of solar reflecting surface from horizontal may also be increased. Increasing the angle of solar reflecting surface from the horizontal plane can be a consideration in precipitation runoff and surface dirt accumulation, as described in more detail below.

Surface Patterning One hybrid cool roof design for achieving its objectives is to form a three dimensional pattern such that one surface oriented towards the sun would be flat or nearly flat, while the bulk of the material is oriented so that when applied to the roof, the solar surface would have that flat angle. This can be accomplished in a number of substrates, by example to ceramic materials and metallic materials, among others. The solar reflective material can be applied after the texture is formed in the roof.

Manufacturing Numerous different manufacturing processes can form the texture of the cool roof tiles. Examples of these processes are rolling and stamping, casting, and thermoforming, among others. The scale of the material that provides the solar reflectivity in the roof can be on the microscopic scale or macroscopic. The features can range in size from microns to centimeters.

Selective Coating The solar reflective material hybrid cool roof is typically applied to the solar reflecting surface. There are many processes known for depositing films that coat only in one direction. One such method for depositing a film is cathodic arc deposition. This process can deposit both metals and metallic oxides. Materials deposited for solar reflection can include titanium dioxide, tin oxide, and other oxide materials, among others

The solar reflective film can be made up of stacks of oxide materials to increase the solar reflectivity. These film stacks could have thicknesses ranging from about 1 μm to 1000 μm, such as about 10 μm to 100 μm and also including about 30 μm to 50 μm. The color of the esthetic surface can have its color inherent in the material that comprises the substrate. This color can be intrinsic to the material or can be produced by dye, pigments, and/or particles added to the material.

Additional Applications The functional characteristic of the hybrid cool roof system can also be incorporated into building siding in the same manner as the roofing application, with consideration taken of the steeper angle of the street view. Beyond building siding applications, the hybrid cool roof principles can be applied to vehicles, such as boats, trucks, among others.

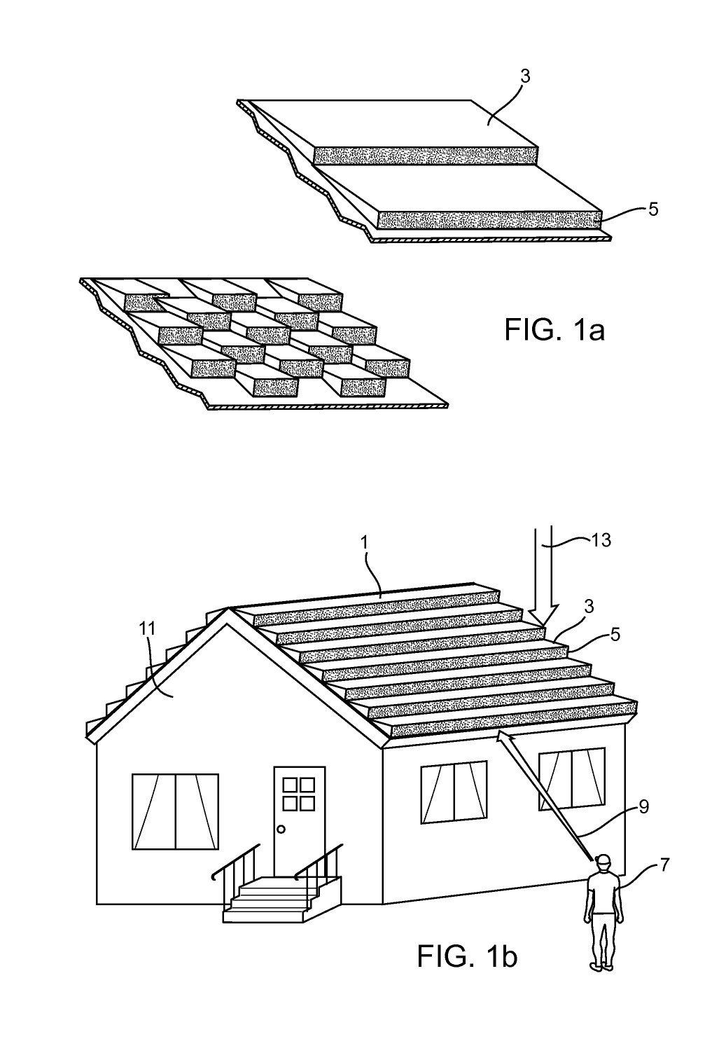

FIG. 1 provides a generalized view of a segment of the hybrid cool roof 1, and a larger view of the hybrid cool roof 1 installed on a building 11. The view in FIG. 1a shows the upper surface of hybrid cool roof 1 being provided with solar reflecting surface 3 and esthetic surface 5. The solar reflecting surface 3 is generally horizontal, and esthetic surface 5 is generally approaching a perpendicular angle. The solar reflecting surface 3 will typically be white or light colored. The esthetic surface 5 will typically be of a dark color, but can be selected from any desirable color or texture. In FIG. 1a, examples are provided of the roof material in the form of a series of longitudinal steps, and alternately as staggered elements.

In FIG. 1b a generalized, 6 foot high person 7 is shown viewing the hybrid cool roof 1 installed on building 11 from street view 9. From the perspective of person 7, the hybrid cool roof 1 will appear to be of the material, color and texture of the esthetic surface 5. Thus, the solar reflecting surface 3 is completely obscured from the view of the observer. In this way, the materials and colors selected for solar reflecting surface 3 can be optimized for functionality without regards to esthetic concerns. Note that solar view 13 showing the trajectory of the sun's radiation at its zenith, is essentially perpendicular to solar reflecting surface 3, providing optimal reflectance.

The surface features of the hybrid cool roof 1, that is solar reflecting surface 3 and esthetic surface 5, can be provided to the building roof surface in the form of separate roofing tiles, or in a monolithic installation sheet. In FIG. 1, these surface features are shown without regard to the foundational form in which they will be applied to the building roof. The hybrid cool roof 1 can be installed as staggered elements, similar to traditional roof tiles, in longitudinal steps, or as a monolithic roof element, among other functional units.

As shown in FIG. 1b, when hybrid cool roof 1 is installed on the surface of a building's roof, solar reflecting surface 3 is typically situated horizontally, or nearly so. Thus, when selecting a particular design for the cool roof 1, the roof pitch is taken into account in order to provide the correct angle of solar reflecting surface 3. The design would be such that it would be relatively specific for each roof pitch where it would be installed with a range of acceptable roof pitches.

Roof pitches may be standard in newer buildings, but given historic buildings, in some cases they are non-standard, such as shown in FIG. 15. In those cases, preformed hybrid cool roof segments will be selected to best approximate a nearly horizontal position for the solar reflecting surface 3. This design consideration will influence the choice of pitch of supporting members in the hybrid cool roof system.

In some embodiments of the hybrid cool roof 1, the solar reflecting surface 3 can be angled from the horizontal from about 0-25°, such as about 2-15°, and including about 3-8°.

The sunlight 13 strikes the portion of the hybrid cool roof 1 that has been treated to reflect solar radiation, that is solar reflecting surface 3. The angle the roof material is viewed from street view 9 by person 7. As a result, the solar reflecting surface 3 that is treated to reflect solar radiation is not seen by person 7. The solar reflecting surface 3 that reflects solar radiation can thus have a large size where the individual elements are visible by the unaided eye. From street view 9, or even a significant elevation, there is quite a bit of latitude for a surface that someone would see versus the surface that would be visible from the sun.

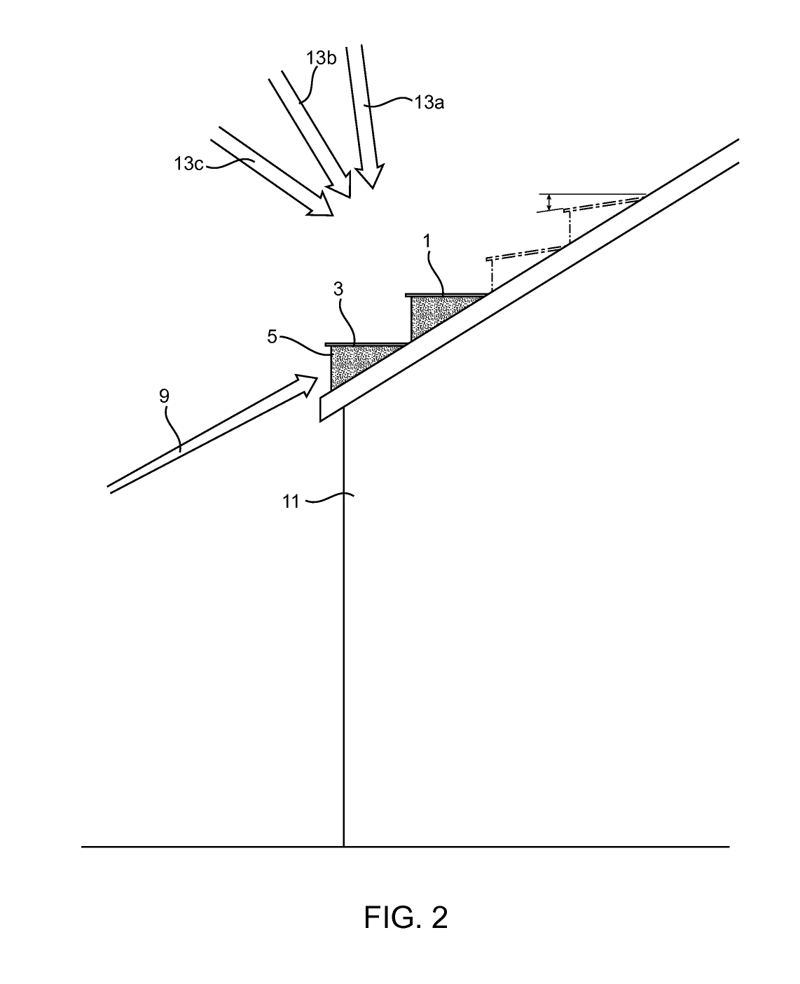

FIG. 2 is a cross section of the hybrid cool roof showing seasonal variations of its function. A single hybrid cool roof 1 is illustrated for the purposes of clarity in this figure, but the hybrid cool roof would typically be completely tiled with multiples of this unit.

As the hybrid cool roof 1 goes through the seasons, the angle of sunlight 13 (in this case mid-summer), as it strikes the solar reflecting surface 3 and esthetic surface 5, will begin to drop with the approach of winter, to the late summer angle of sunlight 13a, proceeding to the fall angle of sunlight 13b, to the winter angle of sunlight 13c. Apparent from this figure is that, as the cooler months approach, the angles of sunlight 13a-c will progressively strike the solar reflecting surface 3 less directly. Concomitantly, the angles of sunlight 13a-c progressively strike the esthetic surface 5 more directly. This natural rhythm of the seasons causes less cooling of the impact of the sun's rays by solar reflecting surface 3, and a useful warming of building 11 as a result of the increased solar radiation to esthetic surface 5.

Thus, a key, inherent advantage of the hybrid cool roof construct in the wintertime, as well as late fall and early spring, is that typically dark esthetic surface 5 can actually absorb heat and become more of a traditional dark roof in function. In this manner solar heating is provided by the hybrid cool roof in the winter. That is a function which is something lost on a solid, conventional cool roof building. However, the hybrid cool roof would have the cool roof properties in the summer time due to the solar reflecting surface 3.

FIG. 15 provides guidance in design considerations to those of ordinary skill in the art optimizing the hybrid cool roof design for specific applications in this regard.

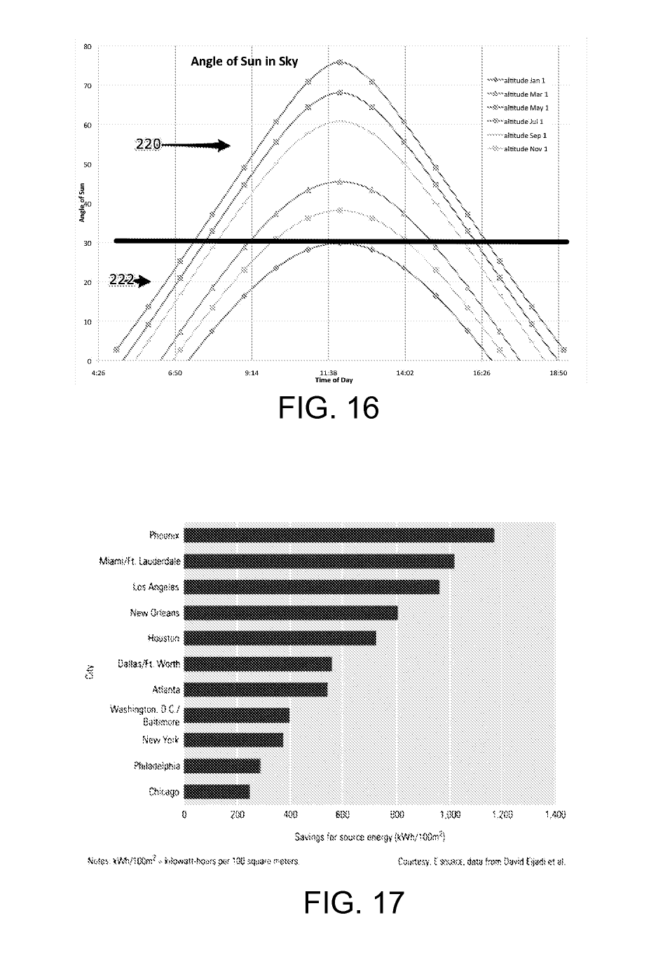

FIG. 16 shows the angle the sun as it passes through in the sky for a particular latitude. During months where the ambient temperatures are more likely to be hot, the angle 220 of the sun in the sky is large. During the winter months the angle 222 the sun is at in the sky is lower. The lower angle corresponds to the street view for the roof material.

The most challenging segment of a roof in terms of a cool roof is the side that faces south, or southwest for most of the latitudes in North America. As in FIG. 16 above, the sun angle changes as it goes through the seasons providing seasonal variation. As the season changes, in the winter the angle is such that the roof would now be able to capture sun. When calculations are done of the total cost of ownership in terms of the cost for air conditioning and heating through a building's life, through the yearly cycle, by design, a complete cool roof does not pick up much heat. Therefore, there is actually a penalty paid in the winter time due to the lack of heating. However, the hybrid cool roof is able to reap the advantages of both cool and conventional roofs in terms of temperature modulation through the seasons.

FIG. 17 shows energy savings from cool roofs in different regions, in this case on commercial buildings. This data demonstrates that cool roofs have different performance in different climates. They save the most in warmer climates and at lower latitudes. The net energy gain from conventional cool roofs becomes less and less at higher latitudes and in colder climates. This differential has limited the adoption of cool roofs in many regional markets.

While this regional difference in conventional cool roof performance is due in part to the lessened requirement for cooling, it is further increased because conventional cool roofs will actually compromise the solar gain of a building in cold weather, producing a net heat deficit.

Many different tile form factors can be used to optimize the hybrid cool roof for specific applications or environments. Tailored hybrid cool roof designs can be provided to optimize the hybrid cool roof's advantages in specific regions. One aspect of the design selection for the features of the hybrid cool roof to consider is the size of the form factor. Each can optimize for a particular delivered advantage best suited to an intended used of the hybrid cool roof.

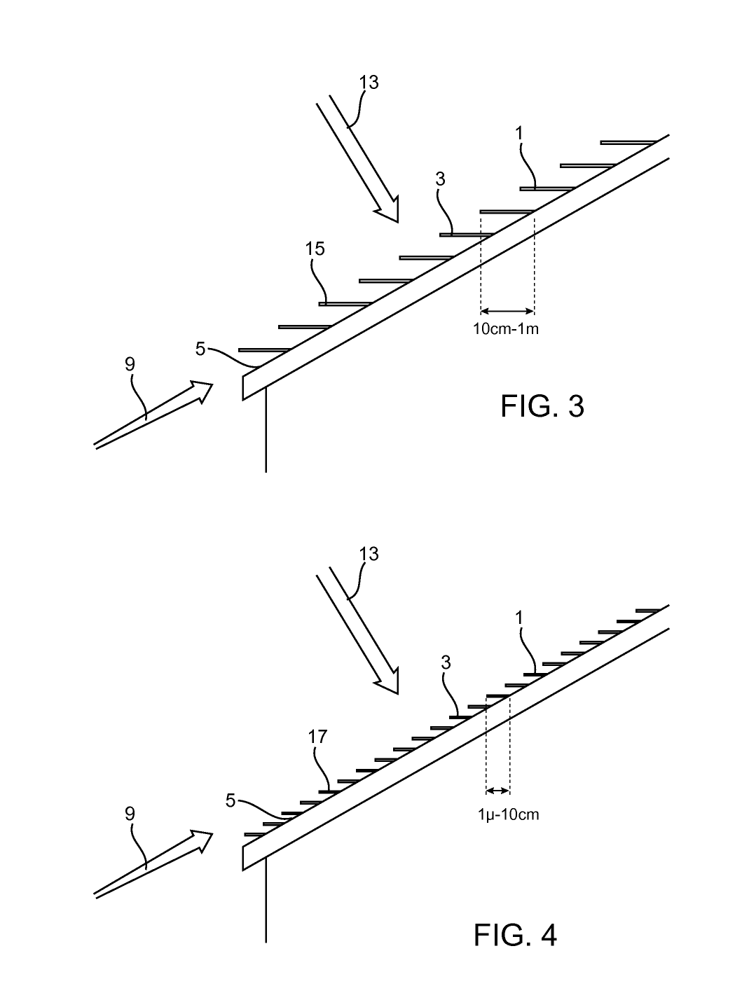

FIG. 3 is a cross sectional view of the roof material of the hybrid cool roof 1 using a relatively large form factor for the solar reflecting surface 3. In this case, a portion of the surface of the material is oriented towards the angle of sunlight 13. The sunlight strikes the solar reflecting surface 3. The angle the roof material as seen from street view 9 does not see the solar reflecting surface 3, but only esthetic surface 5. The large individual surfaces 15 that reflect solar radiation can have a large size where the individual elements are visible by the unaided eye.

In FIG. 4, as in FIG. 3, the surface of the material of the hybrid cool roof 1 is oriented towards the angle of sunlight 13. The sunlight strikes the solar reflecting surface 3. The angle the roof material as seen from street view 9 does not see the solar reflecting surface 3, but only esthetic surface 5. The small individual surfaces 17 that reflect solar radiation can have a small size where the individual elements are too small to be visible by the unaided eye. These individuals surfaces 17 can be, for example, about 1μto 10 cm, or larger.

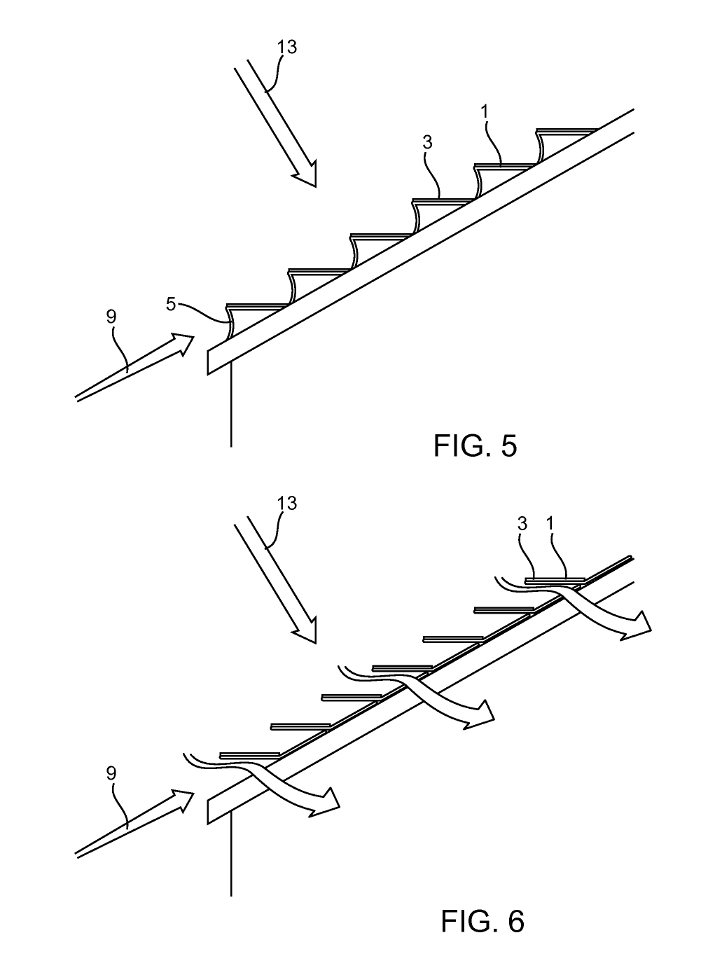

In FIG. 5, the surface of the material for the hybrid cool roof 1 is oriented towards the angle of sunlight 13. The sunlight strikes the solar reflecting surface 3. The angle the roof material as seen from street view 9 does not see the solar reflecting surface 3, but only esthetic surface 5. The reflecting surface 3 can be a series of steps, blocks or ledges. In this embodiment of the hybrid cool roof, the substrate is of micro-steps from 0.3 cm to 13 cm in height, and can be constructed of plastic, ceramic or urethane substrate, among others. Note the curvature of the nose of the esthetic surface 5. This curvature provides some protection for the solar reflecting surface 3 below from dust and dirt. Additionally, the curvature provides an additional visual façade feature to the entire construct.

In FIG. 6, the surface of the material hybrid cool roof 1 is oriented towards the angle of sunlight 13. The sunlight strikes the solar reflecting surface 3. The angle the roof material as seen from street view 9 does not see the solar reflecting surface 3, but only esthetic surface 5, which in this case is both the roof sub-surface and the underside of the hybrid cool roof 1. In this embodiment of the hybrid cool roof, passageways 19 allow humidity and hot air to escape from under the roof material. The coating provided to the solar reflecting surface 3 is not visible from the street view 9.

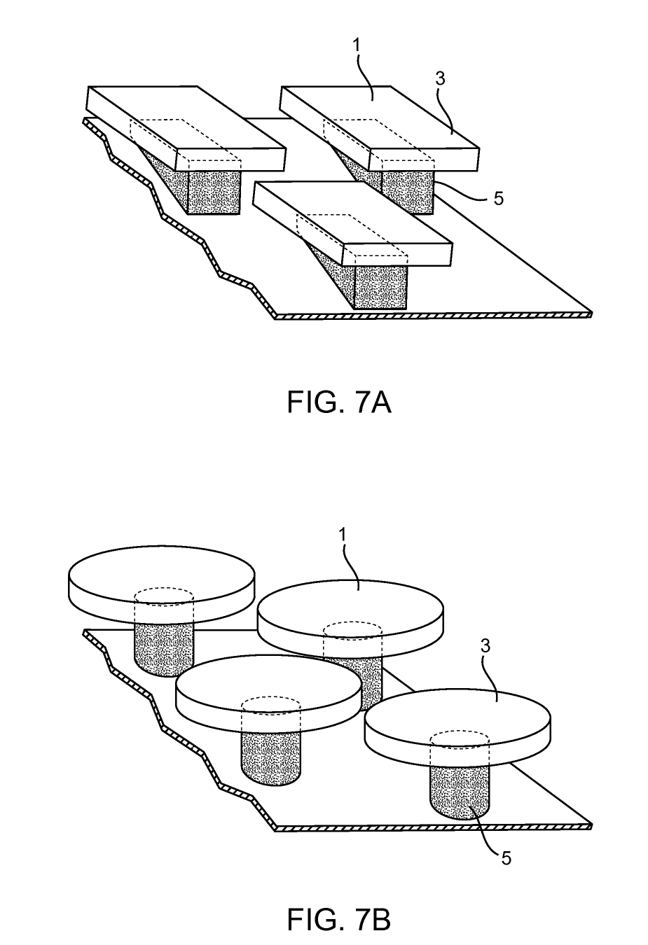

FIG. 7a In this embodiment of hybrid cool roof 1, the esthetic surface 5 is a stand alone rectangular pillar, and provides support for the solar reflecting surface 3, which in this case is also rectangular. The scale of these features is small, in the centimeter range. Thus, there are limited concerns with wind or precipitation compromising the structure or its attachment. This design minimizes the thermal transfer from the esthetic surface 5 and solar reflecting surface 3 to the base of the roof structure. Note that the table-top form of the solar reflecting surface 3 will permit its undersurface to be observed from street view 9 in some cases. Therefore, it may be preferable to treat this undersurface and edges with an esthetic surface similar to esthetic surface 5. This open structure embodiment of hybrid cool roof 1 provides for an increase in air flow, and thus will aid in the self-cleaning of the surface of hybrid cool roof 1.

FIG. 7b In this embodiment hybrid cool roof 1, similar to FIG. 7a, the esthetic surface 5 element is a stand alone cylindrical pillar, and provides support for the solar reflecting surface 3, which in this case is in the form of a circle. As in 7a the scale of these features is small, in the centimeter range. This design is analogous to nail heads, where nails are implanted uniformly on a support surface. Thus, there are limited concerns with wind or precipitation compromising the structure or its attachment. In this embodiment of the hybrid cool roof 1, solar reflecting surface 3 forms discreet surfaces that shade the base of the roof structure. The esthetic surface 5 element provides support for and minimizes the thermal transfer to the base of the roof structure solar reflecting surface 3.

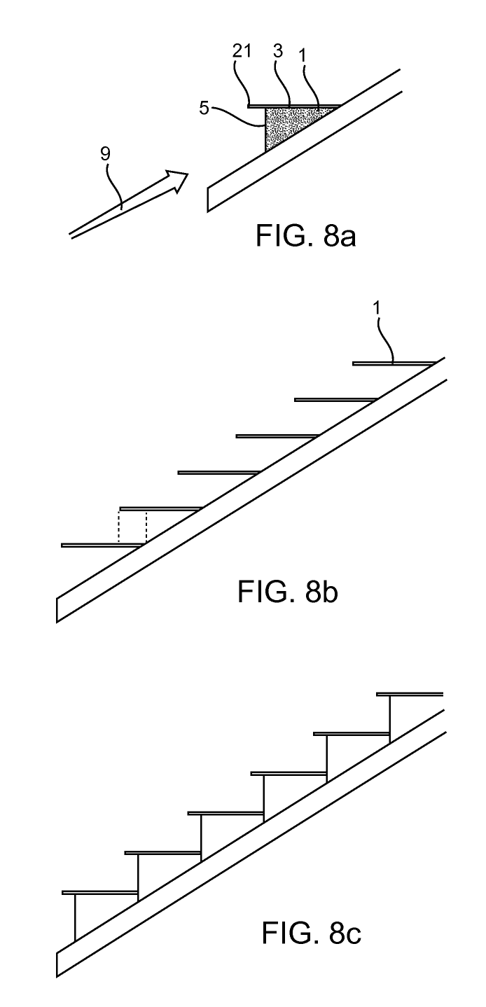

In the FIG. 8a embodiment of hybrid cool roof 1, solar reflecting surface 3 is provided an overhang 21, producing an edge strip. This edge strip overhang 21 provides additional shading of the dark-colored view surface, and in some cases the underside can be seen from street view 9. This overhang 21 is particular advantageous when the solar reflecting surface 3 and esthetic surface 5 are a centimeter or larger, or even half a centimeter.

Depending on the design and intended use of hybrid cool roof 1, overhang 21 can range in size from about 0.5 cm-30 cm, such as about 1 cm-10 cm, and including about 5 cm-7 cm.

This hybrid cool roof embodiment can be fabricated with the elastomeric material for the solar reflecting surface 3. The material is commercially available from a number of different manufacturers, such as EDPM and PVC elastomeric materials with a titanium dioxide, zinc oxide components or coating. In addition, it can be fabricated such that there is a darker edge strip just to cover up the 40 mm or 60 mm surface. This can be molded with a darker edge strip for the overhang 21 to complete the illusion of a dark-colored roof.

As shown in FIG. 8b, the FIG. 8a embodiment of the hybrid cool roof 1 can be constructed with elastomeric material installed over a thermal spacer in a reel-to-reel fashion. With this approach, the hybrid cool roof 1 would be pre-assembled with multiple steps. This preassembled construct would be installed on the roof.

As an additional manufacturing method, as shown in FIG. 8c, the FIG. 8a embodiment of the hybrid cool roof 1 can be manufactured with a ceramic or concrete tile with these facets in place. Ceramic tile, concrete tile, stamped metal or any other appropriate material would also work with this configuration. As such, virtually all the standard roofing materials would work for this embodiment. Alternatively, this same method can be used to retrofit existing roof installations.

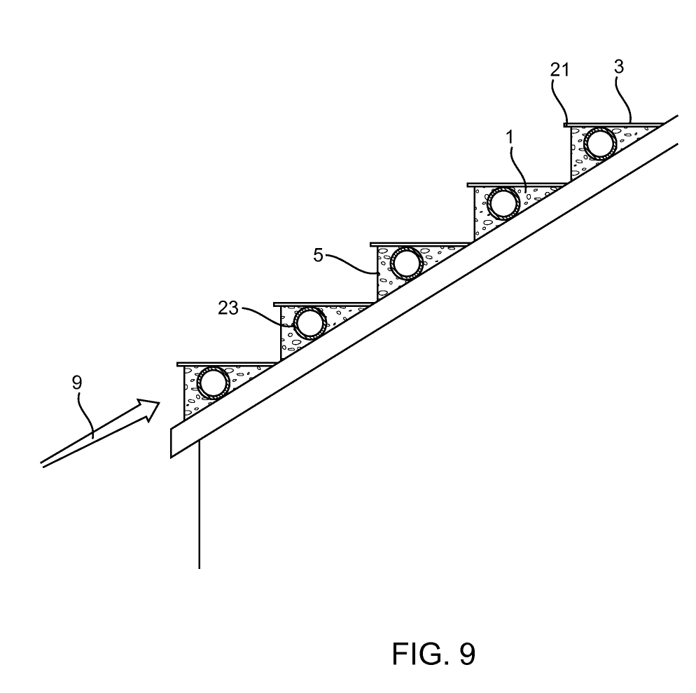

FIG. 9 shows a cross section of an embodiment of the hybrid cool roof where the reflecting surface 3 is provided with an overhang 21. In this case, the hybrid cool roof 1 is built up of spacers. The spacer has the color of the esthetic surface 5 that would be visible by the street view 9.

The installation is setup in overlapping fashion the same way conventional roof shingles are traditionally layered. In the case of polymeric and elastomeric materials, the units are assembled so that the spacer provides the flat surface in a manner that the sun view is properly oriented in the installed room. Each hybrid cool roof 1 assembly then continues up to the next assembly so they are overlapping. This configuration serves to prevent water leakage, wind effects, etc.

In addition, as shown in FIG. 9, piping or other conduits 23 can be installed for either a fluid or gas to actually get heating in the winter time from the surface that, due to the lower sun angle, faces the winter sun. Therefore, in this embodiment, the winter sun is leveraged to pick up additional heat for the heating of the building or hot water supply.

As shown in FIG. 9 this embodiment of the hybrid cool roof 1 is compatible with photovoltaic installation above it. This configuration of hybrid cool roof 1 provides advantages by keeping the temperature of the roof cool. In turn, this increases the efficiency of the photovoltaics. It is well established that photovoltaic cells operate at higher efficiencies at lower temperatures. Thus, this configuration of hybrid cool roof 1 provides an additional synergy with photovoltaic electrical production.

A finer point is that an overhang 21 over the solar reflecting surface 3 provides additional shading of the esthetic surface 5 that increases the cooling of the roof in the summer time. This effect reduces the heat gain in the summer time, and does not interfere with the ability of the roof to capture heat in the winter time.

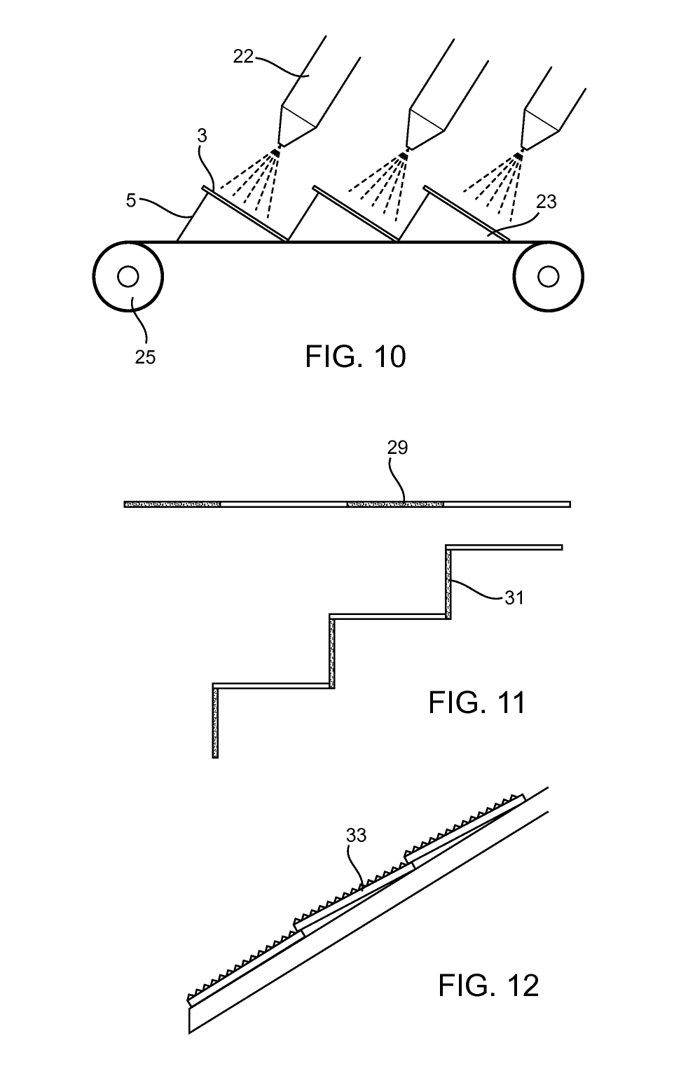

As shown in FIG. 10, for use in the fabrication of the hybrid cool roof, concrete tile, ceramic tile or metal tile 23 can be constructed so that it is fabricated on a linear conveyor belt 25, in a continuous system. Spray head 27 deposits the solar reflecting surface 3 on one side. The esthetic surface 5 is deposited on a reel-to-reel basis. The type of the coatings put down on each surface depending on the surface view and orientation once installed. There are a number of methods to aerosolize these manufacturing components to provide reel-to-reel processing.

As shown in FIG. 11, for use in the fabrication of the hybrid cool roof, the elastomeric material and the metal on flat strips 29 are formed as part of the manufacturing process. The flat strips 29 are formed with the different colors needed for the final roof tile to achieve the correct functionality. Flat strips 29 are then either thermally formed with the elastomeric or formed with metal-forming machinery to form the steps 31 in the material. In this process, a flap is formed and then either hot-welded or otherwise fixed in place. Steps 31 can be formed on a roll-to-roll basis by seam welding the different materials together, using the hot air process to seam the structures. This can be accomplished either from a flat form or a pattern from the start.

FIG. 12 shows the direct installation which the prefabricated hybrid cool roof modules allow. All these modules can be fabricated such that the properties of the roof will already be established. Therefore, the hybrid cool roof construction modules 33 are installed on roofs to match various slope angles, as described in FIG. 15. Construction modules 33 can be installed in the same manner as conventional roofs are installed. By example, if the construction modules 33 was in the form of a tile or sheets, each successive tile installation would overlap the prior tile a bit to keep out rain water. This installation is similar to standard concrete, ceramic or polymer modules. Each one has the smaller features that provide the effect at a smaller scale. In the case of very small features, the visual effect is one of a sand-paper type texture.

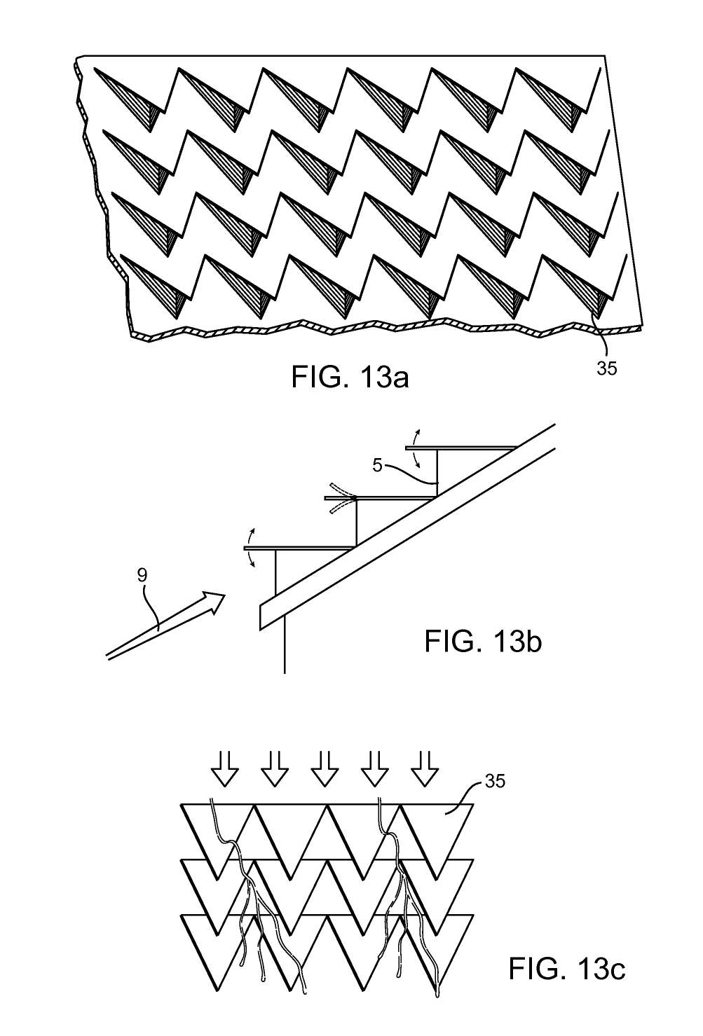

Beyond simple linear slats of this surface design, FIG. 13 shows additional embodiments where the surface has pyramidal shapes 35 or other shapes. The pyramidal shape 35, by example, is shown in FIG. 13a. Besides the functionality described above, these embodiments provide additional esthetic texture and shading of the surfaces as the sun goes through its daily and seasonal angles. By example, the surface can have multiple facets or rounded shapes. In addition, the scale of the facets can be varied throughout the tile and from tile-to-tile to provide additional texture and appearance enhancements.

In FIG. 13b, the esthetic surface 5 is shaded by an overhang 21, which serves to increase the shading and the depth of the color of the roof, as well as providing a shading of the tiles underneath it.

Overhang 21 has an additional advantage with the polymeric material providing an overhang, as it provides vibration and motion produced by wind and rain that help shed dirt accumulation over the leading edge of the roofing material.

FIG. 13c shows additional finer details of the top view of the surface. By providing pyramidal shapes 35 or corrugated shapes, water runoff is channeled so that it keeps dirt accumulation off the solar view surface, and the water runs in between the little shapes rather than over the top of them.

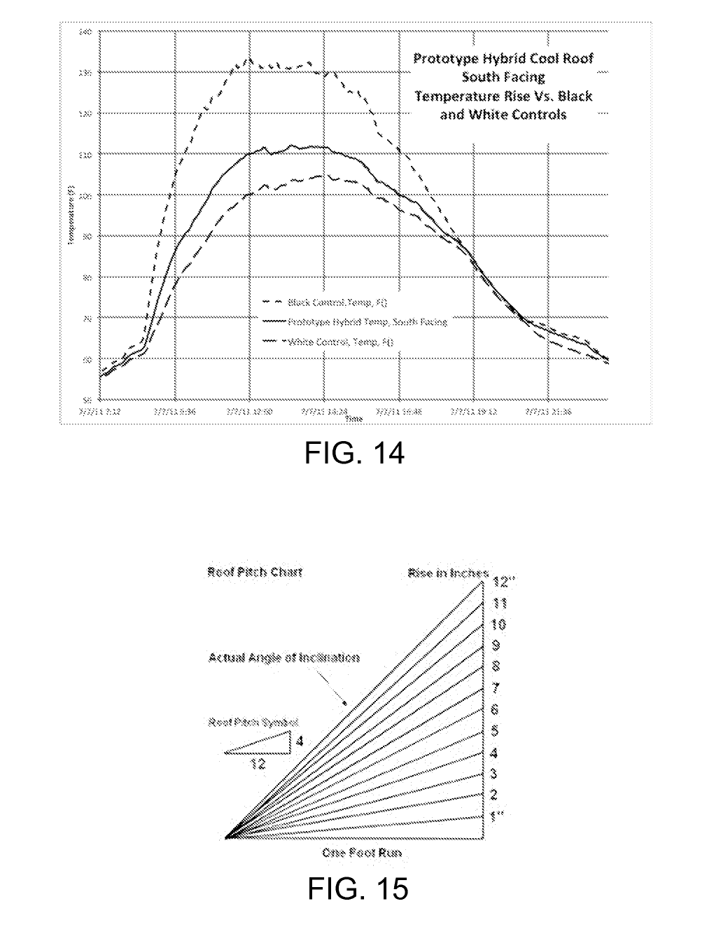

FIG. 14 shows the results of tests demonstrating the efficacy of a hybrid cool roof prototype as compared to standard cool roofs. Even in prototype form, the hybrid cool roof achieves gains very close to those of all white cool roofs, the most efficient currently available cool roof example. This data is for a south facing hybrid cool roof prototype. When fabricated into a whole roof system this data will improve due to the more northern facing tiles being 100% efficient with respect to the sun angle.

1. A hybrid cool roof system comprising,
a solar reflecting surface and
an esthetic surface,
wherein the solar reflecting surface is oriented at or near horizontal, and the esthetic surface is visible to an observer at ground level,
B. hybrid cool roof of claim 1 wherein the hybrid cool roof is provided with reflective features which comprise both the solar reflecting surface and the esthetic surface,
B1. The hybrid cool roof of claim B, wherein the reflective features are about 1μ to 10 cm,
B1a. The hybrid cool roof of claim B1, wherein the reflective features are about 100μ to 1 cm,
B1ai. The hybrid cool roof of claim B1a, wherein the reflective features are about 1 mm to 10 mm,
B2. The hybrid cool roof of claim B, wherein the reflective features are about 10 cm to 1 m,
B2a. The hybrid cool roof of claim B2 wherein the reflective features are about 100 cm to 500 cm,
B2ai. The hybrid cool roof of claim B2a wherein the reflective features are about 300 cm to 400 cm,
C. The hybrid cool roof of claim 1 wherein the solar reflecting surface is provided with a solar reflective coating,
C1. The hybrid cool roof of claim C wherein the reflective coating comprises titanium dioxide, zinc oxide, or a mix of titanium dioxide and zinc oxide,
G. The hybrid cool roof of claim 1 wherein the solar reflecting surface is angled from the horizontal positively towards the roof slope or negatively away from the roof slope,
G1. The hybrid cool roof of claim G wherein the angle of the solar reflecting surface is about −10° to 25°,
G1a. The hybrid cool roof of claim G1 wherein the angle of the solar reflecting surface is about −5° to 15°,
G1ai. The hybrid cool roof of claim G1a wherein the angle of the solar reflecting surface is about 0°-8°,
E. The hybrid cool roof of claim B wherein the reflective surfaces further comprise an overhang,
E1. The hybrid cool roof of claim E wherein the overhang is from about 0.5 cm-30 cm,
E1i. The hybrid cool roof of claim E1 wherein the overhang is from about 1 cm-10 cm,
E1ie. The hybrid cool roof of claim E1i wherein the overhang is from about 5 cm-7 cm,
A. The hybrid cool roof of claim 1, wherein subunits of the roof are provided for installation,
A1. The hybrid cool roof of claim A, wherein the subunits are tiles, shingles, strips or sheets,
D. The hybrid cool roof of claim 1 wherein a substrate is provided,
D1. The hybrid cool roof of claim D wherein the substrate is polymer, ceramic, or metal,
E. The hybrid cool roof of claim A, wherein the subunits are provided with features allowing venting of humidity and heat, features to aid installation, and/or features incorporating thermal insulation,
F. The hybrid cool roof of claim 1 configured for installation as building siding, or on vehicles,
Q. The hybrid cool roof of claim 1 which saves energy costs as compared to conventional cool roofs averaged throughout the year, are from 75%-120%,
Q1. The hybrid cool roof of claim Q wherein the energy savings are from about 80%-110%,
Q1a. The hybrid cool roof of claim Q1 wherein the energy savings are from about 85-100%,
H. The hybrid cool roof of claim 1 which saves energy costs from about 5%-40%,
H1 The hybrid cool roof of claim H wherein said savings are from about 10%-30%,
H1a The hybrid cool roof of claim H1 wherein said savings are from about 15-20%,
J. The hybrid cool roof of claim 1 which improves the roof lifespan as compared to traditional roofs by about 1-30 years,
J1. The hybrid cool roof of claim J which improves the roof lifespan by about 5-15 years,
J1i. The hybrid cool roof of claim J1 which improves the roof lifespan by about 10 years,
